(19) United States
(12) Patent Application Publication
(10) Pub. No.: US 2005/0258636 A1
(43) Pub. Date: Nov. 24, 2005

(54) Patient privacy label and method of using same

(76) Inventor: Antonio V. Bova, Lewis Center, OH (US)

Correspondence Address: WARD KRAFT, INC., P.O. BOX 938, FORT SCOTT, KS, 66701, US

(21) Appl. No.: 10/850,418

(22) Filed: May 20, 2004

(51) Int. Cl. B42D 15/00

(52) U.S. Cl. 283/81

(57) ABSTRACT

The present invention relates to a pressure sensitive laminate that is used in the preservation of confidential patient information. More specifically, the label of the present invention employs one or more coatings of substantially opaque materials on a substrate such that information provided on a pre-existing patient label or identification area can be readily concealed by the label and the information is not visible from the reverse side of the structure to which the over label has been applied. The label construction further includes a destructible substrate that may use a series of discontinuous and inter operable slits along with a permanent pressure sensitive adhesive to prevent the ready removal of the over label from the surface or article to which it has been applied.

### CROSS-REFERENCES TO RELATED APPLICATIONS

None.

### FIELD OF THE INVENTION

The present invention relates to a pressure sensitive construction that is suitable for use in either a post labeling or post recordation application. More particularly the pressure sensitive product described herein employs a series of measures to preclude the removal of the label once applied to a surface in order to protect against the inadvertent disclosure of individual information previously applied to the surface, such as in the case of a pharmacy bottle or vial or medical form. The label configuration uses at least one substantially opaque coating in its construction to prevent information from being visible and to preclude see through as well as a number of pre-defined slits and/or cuts or destructible face stock that will destroy the label configuration upon attempted removal of the label from the surface to which it has been applied. The label construction is used in the field of medical treatment and is intended for the protection of protected health information.

### BACKGROUND OF THE INVENTION

The use of pressure sensitive products for the labeling is well known. Such products or labels are commonly used in the provision of pharmacy products, treatment of patients and the like and normally are used for the recordation of information and identification of a particular patient or treatment regime. In addition, patient information such as personal information, i.e. name, address, phone and account numbers, as well as treatment information, i.e. times to take medication, exercise, diet, and the like is often provided on patient record charts, clipboards and other devices that are commonly used in the treatment of individuals for conditions or illness.

Recently, the Department of Health and Human Services (“HHS”) promulgated new requirements for health care providers, plans and other participating and covered entities relating to the protection of patient information. The act, known as the Health Insurance Portability and Privacy Act (“HIPPA”) requires that disclosure of such personal information can only be made with the consent of the patient and that such covered entities must undertake such obligations and precautions as are necessary to prevent such unauthorized disclosures from occurring. HIPPA thus requires those entities covered under the act to engage in activities and perform additional steps that previously were not routinely practiced by such entities in order to be compliant with the act and the regulations provided therein and avoid civil and possible criminal penalties associated with not being compliant.

For example, pharmacists routinely may have heretofore simply discarded returned medicant containers (vials, bottles, pouches, etc.) when they were brought back to the pharmacy for refilling of a prescription. Under the act, pharmacists must now attempt to destroy the information that is applied to the containers by attempting to peel the label off, where labels are used, darkening the label or information or some other method or application such as scuffing to conceal the personal information.

As might be expected such protocols and methodology do not result in the complete obliteration, removal or disguising of the personal patient identification information. For example, when attempting to remove a pharmacy label, by peeling, such as a label that one would find on a pill or medicine container, the labels are permanently applied so as not to come off and confuse the patient on dosage amounts or other instructions. As such, these labels cannot be readily or easily peeled off the bottle or vial and may require soaking or embarking on other remedial steps to remove the label. When pressed for time, it is unlikely that the pharmacy staff would engage in such a process and as such, the vial or bottle is likely discarded with a significant amount of personal information still in place and easily detectable. Moreover, simply the attempted peeling up of the label would be frustrating leading to the bottle or medicant container being tossed or discarded before the information had been adequately removed. Thus, in such circumstances the pharmacists may be in violation of the HIPPA act as a disclosure of protected patient information has occurred despite the efforts of the pharmacist or other covered entity.

With respect to attempting to conceal the information on a container by blacking it out with a marker, stylus or other device, the information may still be visible through the bottle or vial on the other side, thus again giving rise to the pharmacist possibly being in violation of the HIPAA act. That is, while the overwriting may have been sufficient to hide the information from view from one surface or angle of the form or vial, the information may still be visible through the vial or the back of the form when held to the light.

In addition, medical charts and forms that might be collected for research purposes, such as research to determine the number of people treated for a particular illness or symptom in a geographic or demographic section of the population also contain information that must be concealed prior to the research organization collecting the information. As such, one must either separate the parts of the form or chart to separate the generic treatment information from the patient information or otherwise attempt to overwrite the information such as through the use of a “X” outs or the like. However, these efforts again may not be completely effective in attempting to remain compliant with the HIPPA act and prevent the inadvertent disclosure of patient information to researchers or others that are not authorized to have patient information.

Regardless of the types of attempts that are being made surrounding the removing or concealing of personal information, such steps unfortunately take time and are not generally viewed as being conductive either in the treatment of the patient or in the operation of a business.

What is needed therefore is an easy to use and effective solution that overcomes the foregoing drawbacks and which can assist the covered entity in remaining compliant with HIPAA and other privacy related codifications and the like.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to a pressure sensitive laminate that provides a substantially opaque covering for a pre-existing patient identification area containing information and/or indicia relevant to the patient, such as a pre-existing label. The patient privacy label assembly of the present invention is capable of completely concealing the pre-existing patient information and may not be readily removed due to the combination of permanent pressure sensitive adhesive that is used to attach the label to the patient identification area and a series of discontinuous and inter operable destruction slits or destructible face stock.

In one exemplary embodiment of the present invention a patient privacy label, is described and includes a substrate that has first and second faces, first and second edges and first and second sides. The sides and edges define a perimeter of the substrate. A first substantially opaque coating is applied to the first face and the coating is substantially contained within the perimeter of the substrate. A second substantially opaque coating is applied to the second face of the substrate and is substantially contained within the perimeter of the substrate. An adhesive coating is applied over the opaque coating on the second face. A release layer is then applied over the adhesive coating to form a laminate with the substrate in which the release layer is readily removable from the substrate when the substrate is ready for application or use as provided herein. A series of slits is applied over the substrate and extends substantially through the first and second faces, the slits are contained within the perimeter of the substrate. The substrate with the first and second substantially opaque coatings applied thereto and the adhesive coating create a patient privacy label sized and configured so as to fit over a previously applied patient label containing personal patient information.

In a still further embodiment of the present invention an article to preserve patient privacy is described and includes an article that has first and second surfaces. The article has patient information applied to at least one of the first and second surfaces. The information contains at least a personal portion and a treatment portion, the information is confined to an area of the article that is normally predetermined or predefined. A patient privacy label is sized and configured to conceal at least the personal portion of the information in the area of the article. The patient privacy label includes a destructible substrate that has first and second faces. An opaque coating is applied to at least one of the first and second faces. The substrate further includes an adhesive that is applied to one of the first and second faces. The patient privacy label is applied over at least the personal portion of the information to conceal at least the personal portion of the information from inadvertent disclosure.

The destructible substrate of the foregoing embodiment may be obtained through the use of destructible face stocks or the substrate may include a series of discontinuous and inter operable slits which will cause the substrate to break apart upon attempted removal.

The article of the present invention is a pharmacy container selected from a group including vials, bottles, pouches, syringes, cans, bags, medicant dispensers and combinations and the like. The article may also be a medical treatment device selected from a group including charts, clipboards, placards, signs, record strips, sign in forms, business forms and combinations and the like.

The slits that are used in connection with the present invention are provided in a discontinuous manner that is there is no continuous connection between all of the slits used in the laminate. In addition, the slits may be provided in a pattern which may be regular and the pattern may be made up of identical elements. Alternatively, destructible face stocks may be used which will pull apart upon attempted removal. Destructible face stocks are available from a wide variety of suppliers including for example 3M of Maplewood, Minn.

In a still further embodiment of the present invention a method of using a patient privacy label, is described and includes the steps of initially providing an article that has personal information relating to a patient provided on the article. Then at least one patient privacy label is supplied. The label includes a destructible substrate that has first and second surfaces, at least one opaque coating applied to at least one of the first and second surfaces and an adhesive applied to at least one of the first and second surfaces. The destructible substrate of the label may include a plurality of slits that extend completely through the substrate which cause the substrate to break apart on removal or alternatively the face stock may be a destructible material. The label is sized and configured so as to cover an area of the article containing the personal information of the patient. Next, the patient privacy label is applied over at least a substantial portion of the personal information so as to permanently conceal the personal information from inadvertent disclosure.

Alternatively, destructible face stocks may be used in the place of slits or cuts. Such stocks generally aggressively adhere to the surface to which they are applied and with the attempted removal the face stock will destroy or come apart as peeling pressure is used.

The foregoing exemplary embodiment may include the further steps of removing a release liner after the step of supplying the patient privacy label and prior to the step of applying the label to the article. The release liner is used to cover the adhesive on the label from inadvertent contact with other surfaces that it is not intended to adhere to. In addition, the foregoing method further includes the step of discarding the article once the patient privacy label has been applied to conceal the personal information contained or printed on the article.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the patient privacy label constructed in accordance with the present invention;

FIG. 2 provides a cross sectional view of the privacy label showing the layers used in the manufacture of the pressure sensitive laminate;

FIG. 2A shows the privacy label construction provided in a padded arrangement;

FIG. 3 illustrates an exemplary use of the privacy label of the present invention in concealing information printed on a pharmacy vial;

FIG. 4 depicts an alternate usage of the privacy label of the present invention as it is used to conceal information provided on a business form or patient chart; and

FIG. 5 provides a block diagram showing the steps used in an exemplary method in practicing the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The present invention represents an easy to use and efficient means by which to conveniently and substantially permanently conceal personal patient information, protected information, from inadvertent disclosure which if it occurs may constitute a violation of the HIPPA act by a covered or regulated entity. The invention uses a combination of elements in order to conceal and prevent the unauthorized removal of the label from the now secured information.

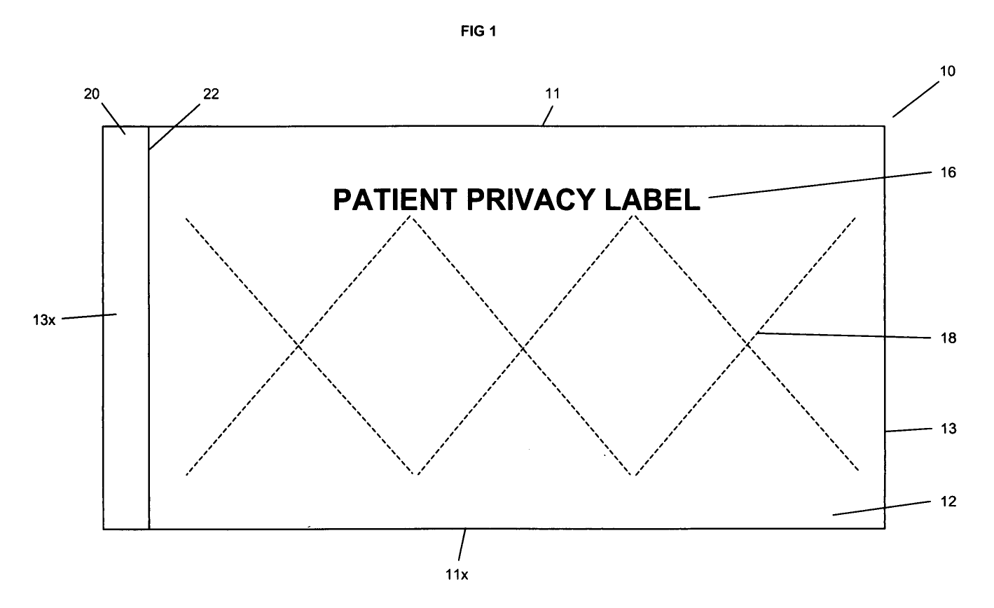

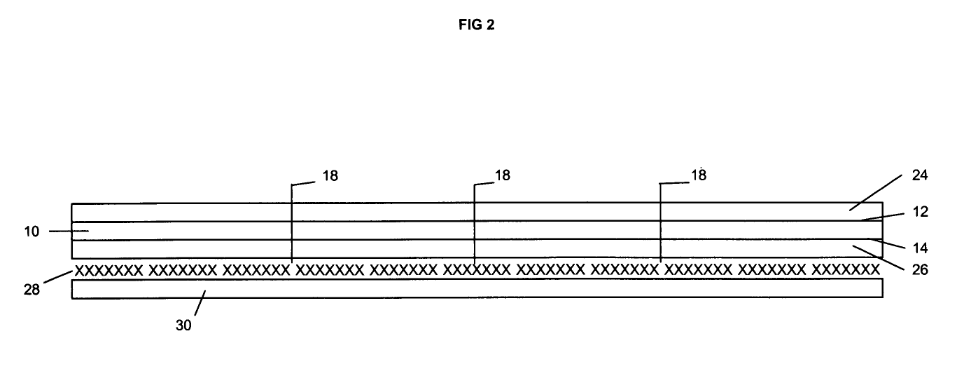

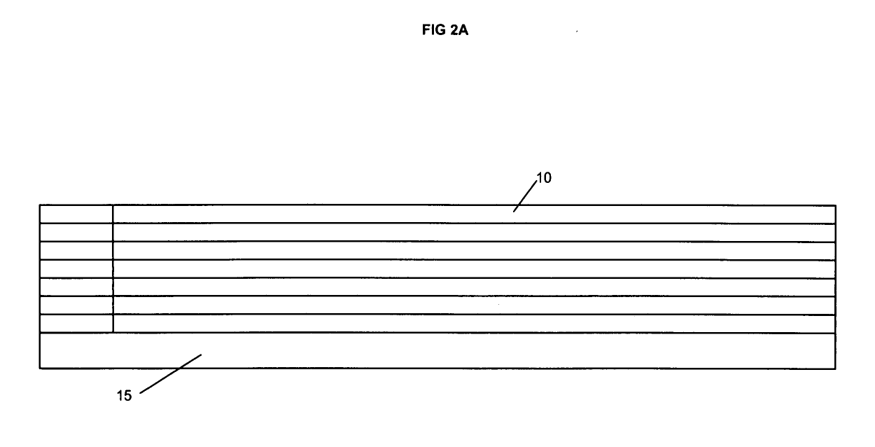

Turning to FIG. 1 of the present invention a front view of the patient privacy label is provided and is generally referred to by reference numeral 10. The label 10 includes a front or first surface 12 and a back or rear surface 14 (see FIG. 2). The front surface 12 may be provided printing 16, such as for indicating the use to be made of the labels. In addition, the label 10 will also be provided with a series of discontinuous slits 18 that are inter operable that may be provided in a uniform pattern and may consist of regular elements. As used in FIG. 1, the elements are depicted as a series of “X's” and are arranged relatively adjacent one another. The slits 18 pass completely through the label substrate 10 so that when attempts are made to pull the label 10 from the surface of a vial, form or the like, the slits will cause the label to break apart thus making removal of the label difficult.

The outer perimeter of the label 10 is defined by side edges 11 and 11* and end edges 13 and 13*.

The label 10 shown in FIG. 1 may also be provided with a separable tab portion 20 that is created through use of a die cut 22. The tab portion 20 can be used to facilitate handling and removal of the label 10 from a pad or continuous sheet of labels in which they were manufactured.

Turning now to FIG. 2, a cross sectional view of the label 10 provided in FIG. 1 is shown. The label includes the substrate 10 having first and second faces 12 and 14. The first face 12 may have a coating applied 24 that is substantially opaque, such as a dark or blackened ink or the like which has limited or little light transmission.

The second face 14 may also be provided with an opaque coating 26 which again may be a dark or black ink. The coatings 24 and 26 may be applied by conventional methods such as through the use of fountains, flexographic printing, gravure and the like. The coatings may be applied over the entire surface to which they are applied or may extend inwardly of a perimeter that is defined by the outer ends and sides 11, 11*, 13 and 13* leaving an uncoated border around the edge. Alternatively, the opaque material can be laid down in patterns, such as geometric shapes or other patterns that would be effective in concealing patient information when the label is applied to the article or substrate containing the patient information.

FIG. 2 also shows the slits 18 extending completely through the substrate 10. In addition, the tab 20 is also shown extending through all the layers of the substrate 10 of the label construction.

The substrate that makes up the label 10 is generally a cellulosic based material, such as 20 or 24 pound bond, but other stocks up to 80 pound tag stock may be used. In addition, the material for the substrate may also be a synthetic (plastic) or metal film depending on the needs of the end user. For example, if a tear resistant material were desired a Tyvek® material may be used as the substrate. The substrate may also comprise destructible face stocks such as vinyl, paper based materials such as are available from the 3M Company of Maplewood, Minn.

The label construction of the present invention is also provided with a layer of adhesive 28. The adhesive 28 is preferably is a permanent adhesive, such as an acrylic adhesive or rubber based adhesive and is applied through use of Meyer rod, coating head, screens or other suitable means known in the industry. The rubber based adhesive is applied through a hot melt process and the acrylic adhesive through an emulsion as will be understood by those with skill in the art. The adhesive should be sufficiently aggressive such that upon the attempted removal of the pre-existing label from an article the, the pre-existing label will likely be destroyed such as would occur through fiber tearing of the pre-existing label substrate.

The adhesive that is used in the present invention may also include an opaque pigment that is randomly and evenly dispersed in the adhesive so as to create an opaque layer, similar to that as coating or printing an opaque layer on to the substrate that forms the label.

FIG. 2 also shows the label construction 10 having a release liner 30 that is disposed over the adhesive layer 18. The release layer, include one side coated with a release material, namely silicone to aid release of the label from the liner. That is, the adhesive has a greater affinity for the label substrate 10 than for the release liner and the adhesive remains with the label substrate.

FIG. 2A shows a stack of individual labels 10 in a padded arrangement. That is a series of labels are connected one to another along a common edge or side and then a backing element 15 is used to support the collection of labels being supplied in the stack or pad.

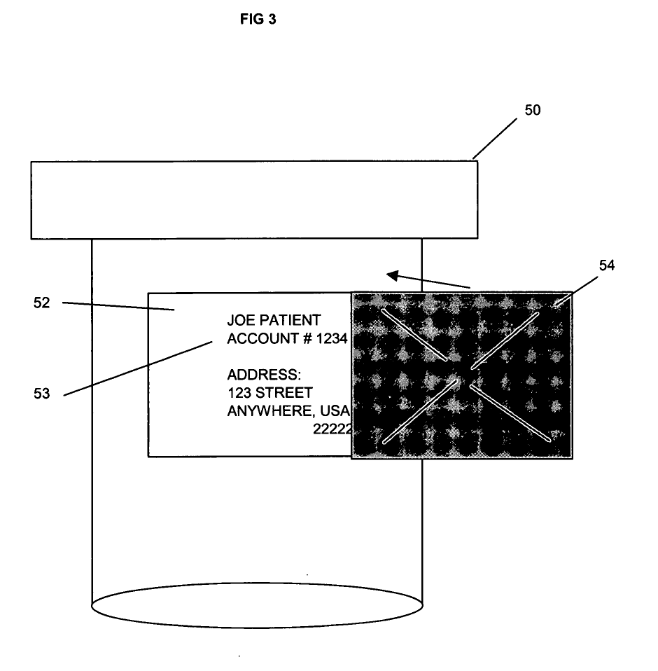

FIG. 3 provides an exemplary use of the present invention and includes an article 50 which is depicted as a pharmacy bottle or vial. It should be understood however that the article may be selected from a group including group including vials, bottles, pouches, syringes, cans, bags, medicant dispensers, charts, clipboards, placards, signs, record strips, sign in forms, business forms or may make up combinations and the like.

The article 50 has a pre-existing label 52 applied to one surface of the article. The article 50 will typically have first and second surfaces and in this instance, a pharmacy bottle the first surface would be the exterior of the bottle and the second surface the interior of the bottle.

The pre-existing label 52 is a pharmacy label and has been imprinted with personal patient information 53, which constitutes protected health information (“PHI”) under the HIPPA act. The patient information 53 is then substantially concealed through use of the patient privacy label 54 as it is applied over the top of the protected information. As can be seen from the drawing, as the patient privacy label 54 is applied over the top of the pre-existing label 52 the opaque coatings will completely conceal the protected health information from view. It should be understood that the pre-existing label can take many forms including a vial label, chart label, wristband or the like.

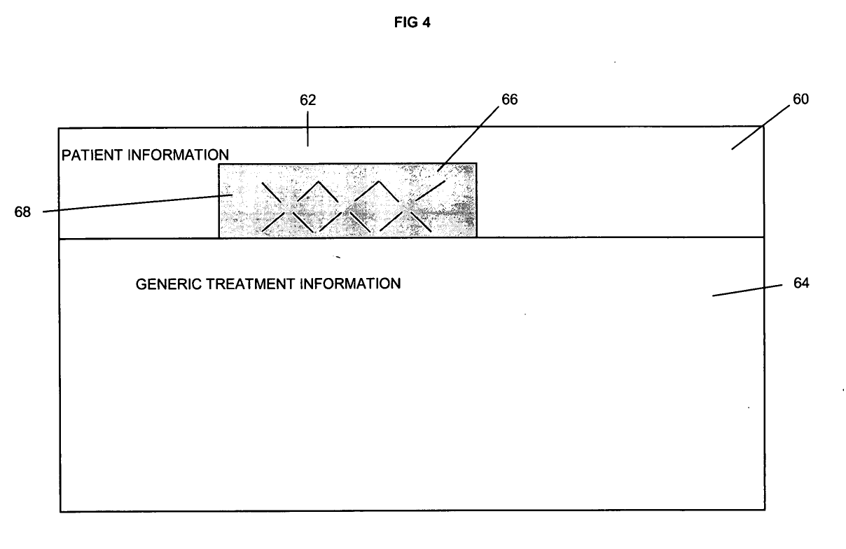

FIG. 4 present an alternative view of the patient privacy label being used with an article 60. In this example, the article 60 is a medical form or chart, which has sections for capturing personal information 62 and generic treatment information 64. The information is generally applied directly to the form or chart as opposed to using a label which is then applied to the vial as shown in FIG. 3. However, it should be understood, that the form or chart may also use a label to provide portions or all of the information to be transferred to the form.

As shown by the FIG. 4 the personal information 62 is covered with a patient privacy label 66 such that the information is no longer visible. As with a form or chart and due to the opaque coating or coating applied to the label construction 66 prevents the information from being visible when the form is viewed from the reverse side of the construction. In addition the attempted removal of the label 66 will cause the label to tear due to the discontinuous slits 68 provided in the construction.

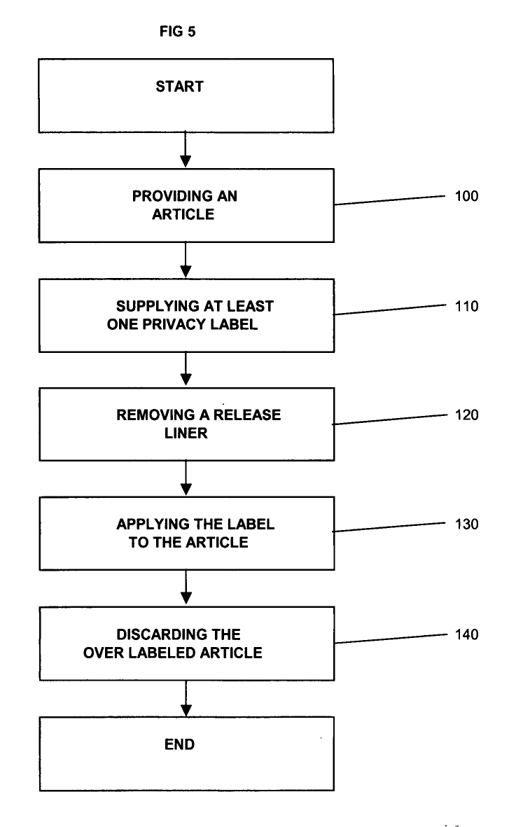

Attention is now directed to FIG. 5 of the present invention which shows a block diagram setting forth an exemplary method of using the patient privacy label. Once the process is started, an article is provided at step 100. The article can again be one that is selected from a group including group including vials, bottles, pouches, syringes, cans, bags, medicant dispensers, charts, clipboards, placards, signs, record strips, sign in forms, business forms or may make up combinations and the like.

Next, at least one patient privacy label is provided at step 110. The privacy label can be provided as a single label or the label may be provided as part of a pad, continuous strip or in any other suitable arrangement. Then, the release liner, if provided, is removed at step 120. Removal of the release liner or label from the release liner is facilitated through the use of the tab shown in FIG. 1. It should be understood however, that a tab need not be provided in order to remove the label from the liner.

The label is then affixed or applied to the article at step 130. The adhesive used in the manufacture of the label is sufficiently aggressive to permanently bind the label to the structure to which it is being applied. The label should be applied to the article such that the entire area of the protected health information is obscured or concealed by the label. That is, the label should substantially cover the patient information. The size of the label should be selected so as to generally cover the area containing the information to be concealed.

Once the label has been secured over the protected health information of the patient, the article may then be discarded at step 140 and the process is stopped.

One of the most important things with respect to new product innovations is the need to effectively market and communicate the new product to potential customers and end users of the product. Such marketing typically includes the creation of marketing collateral associated with the features of the patient privacy label and then selling the assembly in connection with that marketing collateral and then distributing the privacy label to potential end users and customers such as entities covered under the HIPPA act.

Marketing collateral as used herein includes the use of scripted or prepared material that are distributed through audio and visual communication mediums, over a global communication network, through printed mediums such as newspapers, trade publications, magazines, fliers, handouts and the like.

It will thus be seen according to the present invention a highly advantageous patient privacy label and method of use the pressure sensitive construction of the instant specification has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A patient privacy label, comprising;
a substrate having first and second faces, first and second edges and first and second sides defining a perimeter;
a first substantially opaque coating applied to said first face and substantially contained within said perimeter;
a second substantially opaque coating applied to said second face and substantially contained within said perimeter;
an adhesive coating applied over said opaque coating on said second face;
a release layer applied over said adhesive coating to form a laminate with said substrate;
a series of slits applied to said substrate and extending substantially through said first and second faces, said slits contained within said perimeter; and
said substrate with said first and second substantially opaque coatings and said adhesive coating creating a patient privacy label sized and configured so as to fit over a previously applied patient label containing patient information.

2. A patient privacy label as recited in claim 1, wherein said previously applied patient label is a pharmacy vial label.

3. A patient privacy label as recited in claim 1, wherein said previously applied patient label is a medical chart label.

4. A patient privacy label as recited in claim 1, wherein said previously applied patient label is a wristband.

5. A patient privacy label as recited in claim 1, wherein said second substantially opaque coating is contained within said adhesive coating.

6. A patient privacy label as recited in claim 1, wherein said first substantially opaque coating is a printed coating.

7. A patient privacy label as recited in claim 1, wherein said adhesive is a permanent pressure sensitive adhesive and is provided with a substantially opaque pigment dispersed randomly and substantially equally within said adhesive.

8. A patient privacy label as recited in claim 1, wherein said slits are discontinuous and are inter operable and cooperate with one another in the destruction of said patient privacy label upon attempted removal from said pre-existing label.

9. A patient privacy label as recited in claim 7, wherein said adhesive is selected from a group including acrylic and rubber based adhesives and combinations thereof.

10. A patient privacy label as recited in claim 1, wherein said slits are provided in a repeating pattern.

11. A patient privacy label as recited in claim 10, wherein said repeating pattern is composed of identical elements.

12. An article to preserve patient privacy, comprising;
an article having first and second surfaces, said article having patient information applied to at least one of said first and second surfaces and said information containing at least a personal portion and a treatment portion, said information is confined to an area;
a patient privacy label sized and configured to conceal at least said personal portion of said information in said area, said patient privacy label including a destructible substrate having first and second faces, an opaque coating applied to at least one of said first and second faces and an adhesive applied to one of said first and second faces; and
wherein said patient privacy label is applied over at least said personal portion of said information to conceal at least said personal portion of said information from inadvertent disclosure.

13. An article as recited in claim 12, wherein said personal portion of said information is provided on a label which is adhered to one of said surfaces of said article.

14. An article as recited in claim 12, wherein said article is a pharmacy container selected from a group including vials, bottles, pouches, syringes, cans, bags, medicant dispensers and combinations and the like.

15. An article as recited in claim 12, wherein said article is a medical treatment devices selected from a group including charts, clipboards, placards, signs, record strips, sign in forms, business forms and combinations and the like.

16. An article as recited in claim 15, wherein said adhesive is applied so as to at least substantially cover one of said first and second surfaces of said substrates.

17. A method of using a patient privacy label, comprising the steps of;
providing an article having personal information relating to a patient;
supplying at least one patient privacy label, said label including a destructible substrate having first and second surfaces, at least one opaque coating applied to at least one of said first and second surfaces and an adhesive applied to at least one of said first and second surfaces, said label sized and configured so as to cover an area of said article containing said personal information of said patient; and
applying said patient privacy label over at least a substantial portion of said personal information so as to permanently conceal said personal information from inadvertent disclosure.

18. A method as recited in claim 17, including a further step of removing a release liner from said label prior to the step of applying said label to an article.

19. A method as recited in claim 17, including a further step of discarding the article after the step of applying the label.

20. A method as recited in claim 17, wherein said article is selected from a group including group including vials, bottles, pouches, syringes, cans, bags, medicant dispensers, charts, clipboards, placards, signs, record strips, sign in forms, business forms and combinations and the like.

21. A method as recited in claim 17, wherein said label is provided in a pad configuration.
